(19) United States
(12) Patent Application Publication
(10) Pub. No.: US 2022/0394367 A1
(43) Pub. Date: Dec. 8, 2022

(54) WIRED EARBUDS SUPPORT AND RETAINER SYSTEM AND METHOD

(71) Applicants: Alexandra Romanova, Ponte Vedra Beach, FL (US); Fredericus A. Colen, Ponte Vedra Beach, FL (US)

(72) Inventors: Alexandra Romanova, Ponte Vedra Beach, FL (US); Fredericus A. Colen, Ponte Vedra Beach, FL (US)

(21) Appl. No.: 17/805,346

(22) Filed: Jun. 3, 2022

Related U.S. Application Data
(60) Provisional application No. 63/202,271, filed on Jun. 3, 2021.

(51) Int. Cl. H04R 1/02; H04R 1/10

(52) U.S. Cl. CPC H04R 1/026; H04R 1/1016; H04R 1/028; H04R 2499/11; H04R 2201/025

(57) ABSTRACT

A support and retainer system for a wired headphone is herein disclosed. The system includes a stand and a holding device. The stand includes a base, a cradle for supporting a mobile device, with the cradle coupled to the base, and a pair of arms extending from the cradle, with each arm configured to retain a respective headphone wire. The holding device is designed to windably maintain the wired headphone such that the wired headphone can be extended and retracted effectively, quickly, and without becoming tangled, in use.

### CROSS-REFERENCE TO RELATED APPLICATION

This application claims the benefit of priority of U.S. provisional application No. 63/202,271, filed Jun. 3, 2021, the contents of which are herein incorporated by reference.

### BACKGROUND OF THE INVENTION

The present invention relates to a holding and retaining system and, more particularly, to a holding device to hold headphones (e.g., earbuds), for easy use.

Conventional wired earbuds/headphones frequently have the wires get tangled, and it is a difficult problem to avoid. Further, dealing with a lengthy cord (which is oftentimes tangled or easily becomes entangled) does not allow for quick, easy use of the earbuds or other headphones. This makes them impractical for calls, which requires a user to quickly pick up and answer his/her phone (or otherwise miss the call). Consequently, many individuals opt for wireless earbuds/headphones, but those types of products emit electromagnetic field (EMF) radiation, which can pose health risks for the user.

As can be seen, there is a need for a solution that enables effective and quick use of the wired earbuds or other headphones without entangled/messy wires or other issues, to make them more desirable and to provide for the most EMF safe option for consumers. The present invention enables consumers to choose the safest EMF radiation-free hearing device.

By their very nature, wired headphones/earbuds are considered the safest EMF radiation-free option, since they do not contain any high-frequency transmission electronics or antennas. However, as described above, quick access and use of them is often not possible, due to the entanglement of the wires. The present invention resolves these issues, making it convenient to use wired/corded radiation-free headphones.

### SUMMARY OF THE INVENTION

In one aspect of the present invention, a support and retainer system for a wired headphone is disclosed, with the system comprising: a stand comprising: a base; a cradle for supporting a mobile device, the cradle coupled to the base; a pair of arms extending from the cradle, with each arm configured to retain a respective headphone wire.

In certain embodiments, the support and retainer system includes a holding device configured to windably maintain the wired headphone such that the wired headphone can be extended and retracted without the wired headphone becoming tangled, in use

Advantageously, the support and retainer system for the wired headphone enables effective, quick, and untangled withdrawal of the corded earbud or headphones. For example, the pair of arms supporting the wired headphone components (e.g., ear buds, described in greater detail below) allow a user quick access to each ear bud for placement on or in their ear, and easy and effective return to the pair of arms when the wired headphone is no longer needed. The holding device, which is mounted on or immediately adjacent to the stand, enhances the benefits of the stand by adjustably controlling the amount of headphone wire that is exposed from the holding device. Further, the arms and the holding device provide a wire management system that prevents the wires from becoming tangled with each other and themselves.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention.

FIG. 2 is a perspective view, similar to FIG. 1, of the embodiment of the present invention, in use.

FIG. 3 is an exploded perspective view of the embodiment of the present invention.

FIG. 4 is a detail top plan view of the roll-up device of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

As used herein, the term “headphone” encompasses various configurations of audio emitting devices that are positioned on or around the ear, including earbuds (which is a term that is to be understood by its plain and ordinary meaning). As used herein, the term “ear bud” (not to be confused with “earbud”) refers to the component of a headphone positioned in, on, or around a user's ear.

Broadly, an embodiment of the present invention provides a wired earbuds/headphone support and retainer system comprising two arms/upper tentacles to hold the individual right and left earbud, a stand for a mobile device, and a holding device for retaining one or more cords (also used interchangeably with the term “wires”) of a wired headphone or earbud. Further provided is a cylindrical holding system or shell for holding and enabling effective, quick, and untangled withdrawal of the corded earbud or headphones. Embodiments of the present invention provide a system that enables the use of EMF safe, wired headphones and earbuds, even to answer phone calls, and to take the wired device from this system fast and easy. Existing holding devices for headphones and earbuds do not provide for a mechanism to hold the individual earbuds or to roll-up the cable.

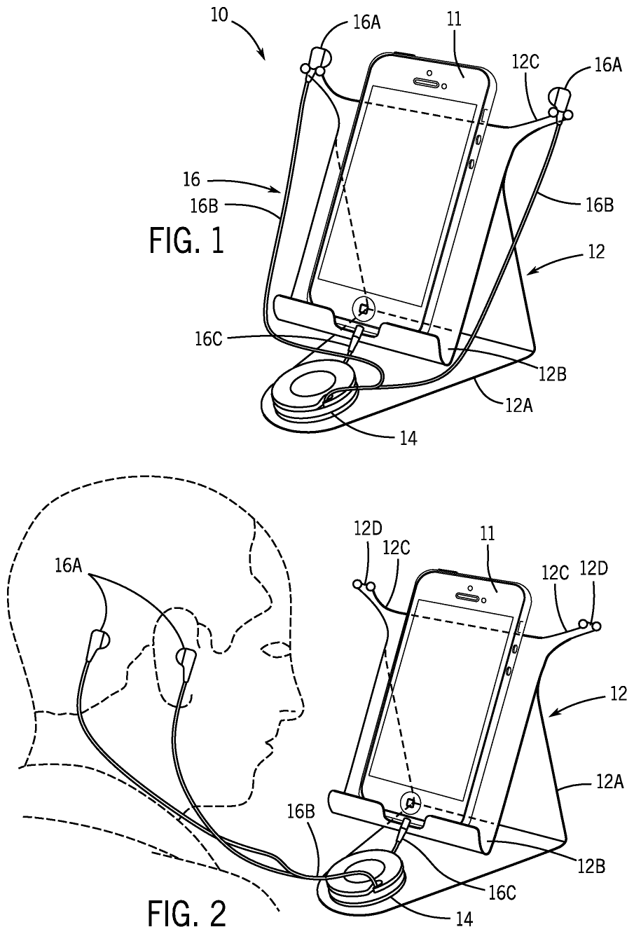

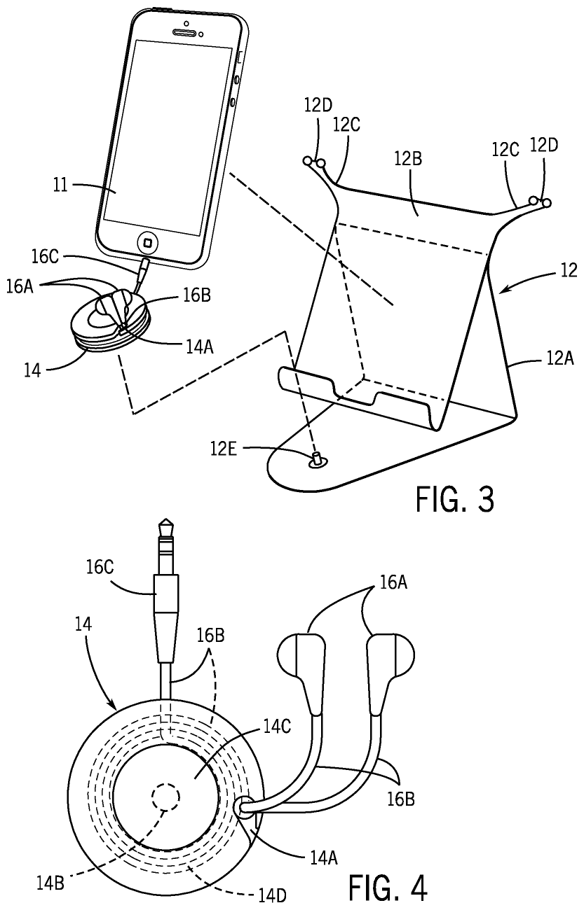

Referring now to FIGS. 1-3, the holding and retainer system 10 includes a stand 12 for supporting a mobile device 11 (e.g., a smartphone or a tablet) and a cylindrical holding device 14 for earbuds 16 (or other headphones). As shown in FIGS. 2 and 3, the holding device 14 is rotatably and removably mounted on the stand 12 (described in greater detail below). As shown in FIG. 4, the earbuds 16 include ear buds 16A (positioned in or on a user's ear), a jack 16C which plugs into the mobile device 11, and a plurality of wires that connect the ear buds 16A with the jack 16C.

The stand 12 includes a base 12A which supports a cradle 12B for holding the mobile device 11. The cradle 12B includes a pair of arms 12C (also referred to as upper tentacles) extending upwardly therefrom, with each arm 12C including an opening/eye 12D at a distal end thereof. These openings 12D are designed to support wire ends 16B distal the ear buds 16A of the earbuds 16 (or other headphones). This separate support specifically for the ear buds 16A individually better ensures the wire ends 16B do not become entangled. As those with skill in the art will appreciate, while earbuds 16 are specifically depicted in FIGS. 1-4, the headphones may take other forms, such that two wires extend to opposing sides of the headphone (and thus can both be supported by the arms 12C). As shown in FIG. 3, the base 12A also may include a pivot pin 12E for reasons discussed in greater detail below.

Referring to FIG. 4, the cylindrical holding device 14 is designed to windably retain any corded earbud 16 or headset (with or without a microphone), in such a way to enable quick unwinding from the cylindrical holding device 14 and use of the earbud/headset 16 (as well as retraction in the opposite direction), while ensuring no entanglement of the cord(s) or parts of the cord(s) of the earbuds/headset 16. The cylindrical holding device 14 may include a reel 14C to roll up and release the cord of the earbuds/headset 16. By way of example, the reel 14C of the holding device 14 may include a manual mechanism to roll up the cord. In other embodiments, the reel of the holding device 12 may include an automated, spring-loaded mechanism 14D to roll up and to release the cord. The holding device 14 is embodied such that the cord of the corded ear buds 16 may be loaded into the holding device 14, so that any pair of earbuds 16 or other headphones can be used with embodiments of the present invention.

In certain embodiments, the cylindrical holding device or shell 14 may have an additional mechanism to hold it in place on the stand 12. As shown in FIGS. 3 and 4, the holding device 14 includes a pivot pocket 14B which rotatably engages the pivot pin 12E on the base 12A. Thus, the holding device 14 can be spun to unwind the earbuds 16 without removing it from the stand 12, keeping the entire system 10 more organized. As shown in FIG. 2, the earbuds 16 can be unwound and placed in a user's ear without needing to remove the holding device 14 or the mobile device 11 from the stand 12.

Further, the holding device 14 may include a pin of suitable shape in the center to enable fixed vs. rotatable front and back plates. The shell may also have one or more slots 14A on the front or the back plate to serve as a stop mechanism and hold the ends 16B of the cord of the earbuds/headphones 16 in place.

In certain embodiments, the cylindrical holding device 14 may be used as a stand-alone item to be carried independently of the complete holding and retaining system, as described above. In this embodiment of the present invention, the individual right and left headphone wires can also be rolled up on the cylindrical holding device 14.

Embodiments of the present invention may be configured such that any device that suffers from tangled cords may be used therewith. Further, methods of making the present invention would be readily apparent to those with skill in the art from the foregoing disclosure. For example, components of the present invention may be formed from a plastic material via an injection molding process. However, any appropriate material and/or process of manufacturing may be used. Certain components, such as the earbuds or other headphones, are commodity items that are required from respective manufacturers, provided that they have the proper specifications to operate in the manner described.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A support and retainer system for a wired headphone, and comprising:
a stand comprising:
a base;
a cradle for supporting a mobile device, the cradle coupled to the base;
a pair of arms extending from the cradle, with each arm configured to retain a respective headphone wire.

2. The system of claim 1, wherein each arm defines an opening that is configured to retain the respective headphone wire.

3. The system of claim 1, further comprising a holding device configured to windably maintain the wired headphone such that the wired headphone can be extended and retracted without the wired headphone becoming tangled, in use.

4. The system of claim 3, wherein the holding device is rotatably mounted on the base of the stand

5. The system of claim 4, wherein the base comprises a pivot pin upon which the holding device is rotatably mounted.

6. The system of claim 5, further comprising the wired headphone, with each arm retaining the respective headphone wires, and the wired headphone windably maintained by the holding device.

7. The system of claim 3, wherein the holding device comprises a reel upon which the headphone wires are rolled up and released.

8. The system of claim 7, wherein the holding device comprises a manual mechanism configured to roll up the headphone wires.

9. The system of claim 7, wherein the holding device comprises a spring-loaded mechanism configure to roll up the headphone wires.

10. The system of claim 7, further comprising the wired headphone, with each arm retaining the respective headphone wires, and the wired headphone windably maintained by the reel.
